(19) United States
(12) Patent Application Publication
(10) Pub. No.: US 2026/0369786 A1
(43) Pub. Date: Nov. 19, 2026

(54) Magnetic Base Attachment for Cordless Tool Batteries Featuring Anti-Warping Structural Supports and Enhanced Magnetic Configuration

(71) Applicant: Preston S. Anderson, Clinton, UT (US)

(72) Inventor: Preston S. Anderson, Clinton, UT (US)

(21) Appl. No.: 19/207,434

(22) Filed: May 14, 2025

(51) Int. Cl. H01M 50/262; H01M 50/227; H01M 50/229; H01M 50/247

(52) U.S. Cl. CPC H01M 50/262; H01M 50/227; H01M 50/229; H01M 50/247; H01M 2220/30

(57) ABSTRACT

A magnetic base assembly for cordless tool battery packs is disclosed, featuring a planar substrate with embedded rectangular magnets arranged to maximize magnetic adhesion to ferrous vertical surfaces. The assembly includes integrally formed or modular vertical support posts configured to align with existing screw holes in the battery housing, thereby distributing fastening loads and preventing deformation or warping of the base during installation. The magnetic layout mitigates negative polarity interference, enhancing magnetic retention strength with fewer magnets. The invention enables secure, non-destructive attachment of cordless tools to steel surfaces for storage and accessibility in work environments such as automotive shops and construction sites. Alternative embodiments include modular magnet cartridges, adjustable support posts, and universal adapter plates to accommodate varied battery geometries. The design preserves full tool functionality and electrical connectivity while enhancing durability and magnetic holding performance across diverse use cases.

### BACKGROUND OF THE INVENTION

### Field of Invention

The present invention relates generally to accessories for cordless power tools and, more particularly, to magnetic base attachments configured for integration with battery packs of cordless tools. Specifically, the invention pertains to magnetic bases designed to be affixed to battery housings of cordless tools, thereby enabling secure magnetic coupling to ferrous vertical surfaces. The invention also incorporates structural features to mitigate base warping during installation, enhancing stability and magnetic retention strength in tool positioning applications.

### Brief Summary of the Invention

The present invention provides a magnetic base attachment designed for integration with cordless tool battery housings, particularly those compatible with Milwaukee-style battery packs. The invention utilizes a strategically configured array of rectangular magnets arranged to minimize negative polarity interference and maximize magnetic retention force against vertical ferrous surfaces. In conjunction with the magnet layout, the base includes integrated support posts that align with factory screw channels on the battery housing. These support posts function as anti-warping structures, distributing mechanical load during installation and maintaining planar contact between the magnetic base and the surface of attachment. As a result, the invention provides a more secure and reliable magnetic mounting solution for cordless tools, reducing the risk of accidental displacement or tool damage during vertical storage or operation in dynamic work environments.

### BRIEF DESCRIPTION OF THE FIGURES

FIG. 1 is a perspective view of the magnetic base assembly showing the enclosing frame, ventilation features, fixing protrusions, and primary base surface.

### DETAILED DESCRIPTION

The invention disclosed herein pertains to a magnetic base assembly configured for mechanical and magnetic integration with portable cordless tool battery packs, most notably those conforming to the Milwaukee M12 and M18 series battery formats. The magnetic base is formed as a monolithic or semi-monolithic body, preferably manufactured from a high-strength, thermally stable polymeric resin capable of withstanding moderate mechanical stress and exposure to environmental contaminants commonly encountered in automotive, construction, and manufacturing settings. Representative materials may include polycarbonate blends, acrylonitrile butadiene styrene (ABS), or reinforced nylon composites. Additive manufacturing techniques such as fused deposition modeling (FDM) or selective laser sintering (SLS) may be employed in prototyping and limited production runs, while injection molding is contemplated for mass production.

The base comprises a primary planar substrate defined by a rectangular or custom-contoured profile, the periphery of which is dimensioned to align flush with the outer boundary of a target battery housing. Said substrate is provided with a plurality of magnet receptacle cavities, each having a geometry corresponding to rectangular neodymium magnets. These cavities are recessed into the lower surface of the base, i.e., the surface directed toward the ferrous contact surface in use. The depth, width, and longitudinal separation of said cavities are selected to ensure consistent placement, secure retention, and optimized magnetic field distribution when the magnets are inserted. Adhesive retention or press-fit tolerances may be employed, with optional mechanical detents for enhanced durability under vibration or thermal cycling.

Situated orthogonally above the primary substrate are one or more vertical support columns, which are integrally formed or affixed through mechanical coupling or bonding. Each support column is precisely located to align coaxially with the factory-installed screw ports of the battery housing. The upper terminal end of each support column includes a through-bore sized to accommodate threaded fasteners, such as thread forming screws for plastic, including M3-1.34 blunt tip screws used in Milwaukee M12 and M18 batteries. Alternatively, standard machine screws may be used where compatible. The columns are dimensioned not only to serve as fastener channels but also as load-bearing structural elements that elevate the main substrate away from the battery casing by a defined standoff distance, thereby preserving the coplanarity of the base under screw torque and preventing structural warpage.

The invention further includes peripheral design enhancements such as chamfered edges, corner radii, and surface textures to assist with ergonomic handling, improve wear resistance, and reduce edge-induced stress risers. Cable routing recesses and notches may be optionally included to accommodate battery pack leads, thermal sensors, or voltage taps, without interfering with the structural or magnetic functionality of the base. Additionally, optional alignment keys or ridges may be disposed along the top surface of the base to assist in ensuring accurate lateral registration of the component relative to the battery pack during assembly.

Collectively, the structural design of the magnetic base facilitates rapid, repeatable attachment to a range of battery form factors, provides mechanical reinforcement to inhibit base deformation during fastening, and establishes a robust foundation for magnet placement and magnetic field projection. The integration of structural support and magnetic interface into a single, cohesive component enables practical, tool-compatible storage of cordless tools on vertical steel surfaces without compromising structural integrity or user convenience.

The present invention incorporates a specialized magnetic array architecture devised to enhance the adherence force of the cordless tool battery base to vertical ferromagnetic surfaces while minimizing magnetic inefficiencies and polarity-based repulsion effects. Central to this configuration is the utilization of high-flux density, rare-earth rectangular magnets—preferably neodymium iron boron (NdFeB) grades N42 to N52—embedded within precisely dimensioned receptacle cavities distributed across the lower face of the magnetic base substrate. The rectangular geometry of the magnets affords both increased surface area contact with the mounting substrate and improved flux continuity when aligned edge-to-edge in prescribed orientations.

The spatial configuration of the magnets is informed by electromagnetic modeling and practical experimentation, wherein it was observed that closely spaced, axially polarized circular magnets suffer from field interference and polarity cancellation in boundary regions. In contrast, rectangular magnets offer greater uniformity in flux vector orientation and allow for the intentional staggering or offsetting of magnetic poles to minimize destructive interference. The magnets are embedded in a pattern such that adjacent units maintain a sufficient spatial offset—typically 5-10 mm between like poles—to ensure unidirectional flux projection and eliminate instances of negative polarity interaction. This deliberate patterning increases the net attractive force while also distributing the magnetic field uniformly across the contact surface.

Furthermore, each magnet is oriented such that its primary field vector projects perpendicularly from the plane of the base, directed toward the intended ferrous substrate. To maintain this vector orientation and resist magnetic flipping or mechanical dislocation, each magnet is secured within its respective cavity by means of interference fit, industrial-grade adhesives (e.g., cyanoacrylate or epoxy resin), or retention clips formed as part of the cavity geometry. The base may include magnetic shielding features, such as ferromagnetic backing plates or polymer barriers with embedded ferrite granules, to direct the field downward and suppress stray emissions that might interfere with nearby electronic systems or degrade field strength.

In high-demand applications, such as automotive lifts or steel-framed workstations, the configuration may support a dual-row or triple-row magnet array, depending on the dimensions of the battery and required load-holding force. The distributed load model ensures that each magnet contributes independently to the cumulative force profile, mitigating the risk of failure due to localized demagnetization, loss of adhesion, or misalignment. Testing demonstrates that the described configuration can yield magnetic adhesion strengths exceeding 30-40 pounds of force, sufficient to maintain positional integrity of a tool weighing several kilograms, even under mild vibrational or angular displacement conditions.

As an additional enhancement, the invention may include magnet recess geometries with tapered or dovetailed sidewalls, which prevent vertical shear ejection under applied torque loads. For applications requiring easy magnet replacement or field customization, a modular cartridge system may be employed whereby magnets are inserted into removable trays or holders which snap into place within the base. This permits users to customize holding force for specific jobsite requirements without replacing the entire base unit.

Through the deliberate engineering of the magnet geometry, pole orientation, spatial distribution, and securing mechanisms, the invention achieves superior magnetic field utilization, reduced polarity interference, and a more reliable adherence interface compared to existing magnetic base designs employing circular magnets or random pole arrangements.

A critical innovation of the present invention lies in its integrated anti-warping architecture, which is engineered to mitigate deformation of the magnetic base during the fastening process and subsequent operational use. Conventional magnetic bases for battery-powered tools often suffer from plastic deformation or torsional warping when subjected to uneven torque loads or prolonged compressive stress, particularly during attachment to irregular battery casings. Such warping undermines magnetic contact integrity, reduces surface adhesion, and contributes to premature detachment or failure during vertical mounting. The disclosed invention addresses this structural vulnerability through a combination of reinforced support elements and load distribution strategies.

The magnetic base is equipped with multiple vertically oriented support posts, which are integrally molded or mechanically affixed to the main substrate and aligned precisely with factory-located screw holes on the target battery housing. Each support post extends upward from the lower plane of the base and features a central bore designed to receive threaded fasteners. These posts serve a dual function: they act as axial compression columns during fastening, thereby redirecting installation torque away from the magnet-bearing substrate, and they maintain a fixed vertical standoff distance between the magnetic surface and the battery housing, thereby preserving planarity across the base.

Each post is geometrically reinforced via ribbing, thickened cross-sections, or filleted transitions between post and substrate to eliminate stress risers and resist buckling under axial load. The height of the posts is calibrated to allow full thread engagement without deflection of the substrate. Additionally, the post array is symmetrically distributed to achieve even load dispersion across the base, minimizing the potential for torsional stress or corner lifting, which are primary contributors to surface misalignment and magnet disengagement.

To further enhance the anti-warping capability, the invention optionally includes a peripheral compression flange or support lip that contacts the battery housing along its perimeter during fastening. This lip acts as a passive brace, constraining lateral deformation and increasing the base's resistance to flexure under torque. The combination of internal support columns and external flanging effectively converts localized installation forces into a uniformly distributed compressive field, thereby maintaining the co-planarity of the magnetic contact surface during and after installation.

In embodiments where removable or modular support columns are utilized, each column may incorporate a keyed locking feature or detent to ensure stable seating and prevent angular rotation under torque. Alternative fastening techniques may include threaded inserts or metal bushings embedded into the posts during molding, thereby enabling the use of machine-threaded fasteners with higher torque tolerances and repeatable assembly without degradation of the post structure.

Environmental factors such as thermal cycling, impact loads, and vibrational fatigue are also accounted for in the anti-warping design. The materials selected for the base and posts possess low thermal expansion coefficients and high dimensional stability. Furthermore, the uniform load distribution imparted by the post network reduces localized strain concentrations, which are known failure points in thermoplastic components subjected to cyclical stress.

The result of this integrated anti-warping mechanism is a robust and durable mounting base that preserves magnetic contact integrity over time and under adverse conditions. The combination of vertically aligned compression posts, geometric reinforcement, distributed torque paths, and edge bracing collectively provides a structural resilience not present in prior art magnetic attachments. These improvements substantially extend the operational reliability of the base in real-world tool deployment scenarios, including construction, automotive repair, and industrial maintenance settings.

The magnetic base system disclosed herein is engineered for rapid, field-deployable installation by end users, requiring minimal technical expertise and no modification to the underlying battery housing. The design prioritizes mechanical compatibility, ergonomic access, and repeatable installation across multiple cordless battery models, including but not limited to the Milwaukee M12 and M18 product lines. The procedure has been optimized to ensure both structural integrity and full magnetic functionality upon completion.

Installation begins by detaching the existing fasteners from the base of the selected battery pack. These fasteners, typically machine-threaded screws, are retained for reuse. The magnetic base is then aligned over the exposed baseplate of the battery housing, with particular attention to the alignment features incorporated into the invention. These may include molded registration ridges, alignment pins, or notched geometries corresponding to structural features of the battery casing. These ensure correct rotational and translational orientation prior to mechanical coupling.

The base is then seated so that each of its integral or modular support posts aligns coaxially with the factory-threaded screw channels of the battery housing. In preferred embodiments, the bore diameters and counterbore depths of the posts are engineered to accommodate common thread forming screws, such as the M3-1.34 blunt tip screws used by Milwaukee in M12 and M18 battery platforms. While current designs use substitute fasteners, future embodiments may adapt to accept OEM screws if manufacturer authorization is obtained. Once aligned, the original screws are reinserted through the top of each support post and torqued to the manufacturer's specified value, thereby anchoring the magnetic base to the battery housing.

This fastening operation is structurally significant: torque loads are channeled directly through the vertically aligned support posts and dispersed uniformly through the substrate, as described in Section 3. This eliminates the risk of bowing, flexing, or cracking during installation. During tightening, a secondary benefit arises—tightening pressure compresses the magnetic base flush against the battery casing, which ensures co-planarity of the bottom surface and maximum magnetic contact fidelity when later affixed to a ferrous surface.

Upon completion of installation, the battery pack, now integrated with the magnetic base, is ready for magnetic deployment. The user may affix the modified battery (and by extension, the tool) to any suitable ferrous vertical surface—such as a steel beam, vehicular chassis, lift post, or workbench wall. The ergonomically accessible perimeter of the magnetic base, optionally chamfered or knurled for grip enhancement, allows users to attach and detach the unit with minimal effort despite the strong magnetic retention forces.

In use, the interface remains passive and requires no active user engagement. The design accommodates the tool's existing electronic connections and charging mechanisms without obstruction. Notably, the magnetic base does not interfere with the terminal ports, locking tabs, or contact interfaces of the battery, preserving full electrical functionality and mechanical compatibility with the parent tool system.

Additional features may include user-serviceable magnet access ports for future replacement or upgrade, as well as identification markers or QR codes molded into the housing for inventory control, model differentiation, or traceability in commercial tool fleets.

This streamlined installation process ensures that end users—whether tradespeople, mechanics, or technicians—can rapidly enhance the functionality of their cordless tools without compromising structural integrity or electrical performance. However, users should be aware that removal of factory-installed screws—even without internal modification—may be deemed sufficient by some manufacturers, including Milwaukee, to void warranty coverage. No warranty preservation is implied.

While the preceding embodiments describe a preferred magnetic base structure designed for Milwaukee-style cordless tool batteries, it is to be understood that numerous alternative configurations, material substitutions, and structural enhancements may be implemented without departing from the scope or spirit of the present invention. This section sets forth contemplated variations that extend the versatility and scalability of the device across a broader range of applications, use cases, and manufacturing paradigms.

In one contemplated embodiment, the structural support posts described in the principal configuration may be reengineered as detachable or reconfigurable modules. These posts may incorporate a keyed bayonet interface, dovetail interlock, or threaded coupling mechanism that permits user-removal or post-installation adjustment. Such modularity enables end users to retrofit or reconfigure the post layout to accommodate non-standard battery geometries or aftermarket battery housings. Additionally, support posts may be fabricated from metallic alloys, such as aluminum or stainless steel, to enhance rigidity, thermal stability, and mechanical resistance under high-load scenarios.

An alternative approach to the anti-warping mechanism may involve the use of sliding or telescoping support structures that automatically conform to the battery housing during installation. These variable-length support mechanisms, equipped with spring-loaded or ratcheting detents, provide self-leveling functionality, which is particularly advantageous in cases where the base must conform to inconsistently molded battery housings or when installed in high-volume assembly environments.

With respect to the magnetic array, while rectangular neodymium magnets are preferred in the primary embodiment, alternative geometries and compositions are expressly contemplated. This includes the substitution of circular, arc-segmented, or trapezoidal magnets arranged in flux-optimized grids. For environments sensitive to electromagnetic interference (EMI), magnets with integrated shielding layers or low-leakage configurations may be employed. Ferrite magnets, while lower in holding force, may be used in cost-sensitive applications or those requiring broader thermal tolerance.

Further variations may include a modular magnet cartridge system, whereby magnet elements are housed in swappable trays that interface with keyed sockets within the base substrate. This system enables users to customize the magnetic strength, pole orientation, or magnet layout in the field without disassembling the entire base. It also facilitates serviceability and reduces costs associated with magnet degradation or accidental demagnetization.

Material alternatives for the base structure may include fiber-reinforced composites, such as glass-filled nylon, or high-temperature thermoplastics like polyetherimide (PEI) or polyphenylene sulfide (PPS), which afford improved dimensional stability and environmental resistance. For metallic variants, die-cast aluminum or stamped steel may be employed with appropriate insulation layers to prevent galvanic interaction with the battery housing.

Further enhancements may incorporate integrated features for specialized applications, such as rubberized contact pads to prevent surface marring, shock-absorbing layers to buffer against tool impact, or embedded RFID/NFC tags for inventory and security control in enterprise or construction fleet contexts. Wireless diagnostic sensors capable of reporting positional status, vibration levels, or temperature could also be embedded into the base, enabling real-time monitoring in critical applications.

Finally, a universal mounting variant is contemplated, wherein the magnetic base is decoupled from a specific battery housing and instead affixed to an intermediate adapter plate. This plate may interface with various battery formats via locking tabs, sliding latches, or custom-fit cradles, thereby enabling a single magnetic base to serve multiple tool systems. Such a universal system would reduce part redundancy and simplify inventory logistics across diverse tool ecosystems.

These alternative embodiments underscore the adaptability of the disclosed invention and reinforce its capacity for customization, scalability, and integration with emerging manufacturing, ergonomic, and operational requirements in the field of cordless tool accessories.

### DETAILED DESCRIPTION OF FIGURES

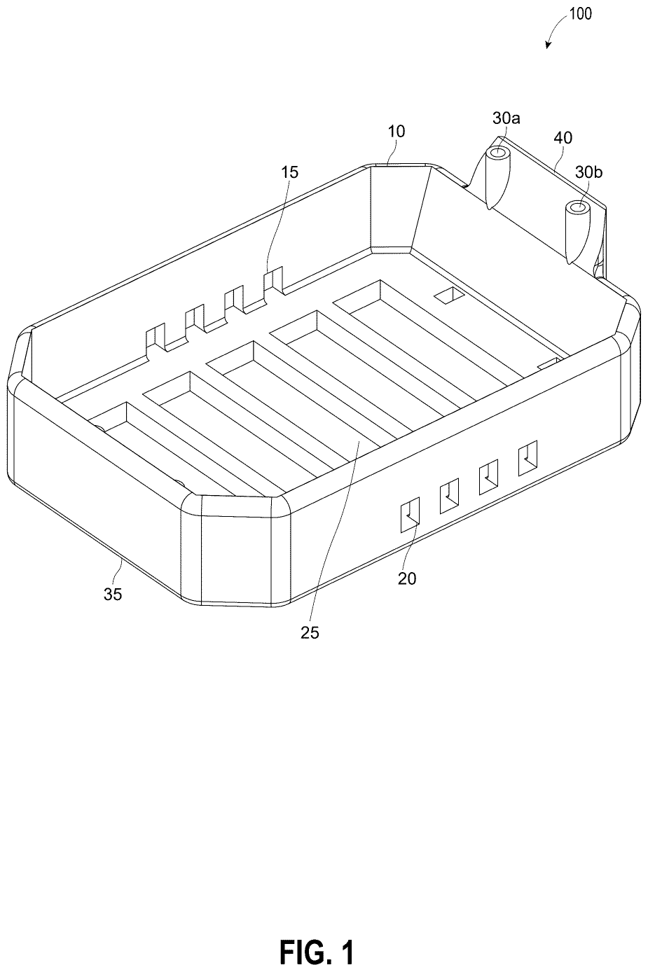

FIG. 1 illustrates a perspective view of the magnetic base assembly (100) configured for attachment to the underside of a cordless tool battery pack. The assembly comprises an enclosing frame (10), which defines the outer perimeter and structural boundary of the device. The frame supports a pair of side vents, including a left side vent (15) and a right side vent (20), each designed to promote airflow, reduce weight, and allow for environmental equalization within the internal cavity. A bottom vent (25) is positioned beneath the base surface and serves to facilitate drainage, air movement, or pressure equalization during installation and use.

On opposite lateral ends of the frame are a left fixing protrusion (30a) and a right fixing protrusion (30b), each projecting vertically to provide structural anchoring points. These protrusions are dimensioned to align with corresponding factory screw holes in the battery housing and are configured to receive threaded fasteners, thereby securing the magnetic base to the battery pack and providing anti-warping load distribution as described in the specification.

The assembly further includes a primary base surface (35), oriented downward in typical use, which houses the embedded magnetic array and interfaces magnetically with ferrous surfaces. This base is designed for co-planarity, mechanical durability, and optimal magnetic field projection, forming the core functional surface of the invention.

What is claimed is:

1. A magnetic base assembly for attachment to a cordless tool battery pack, comprising:
a. a planar substrate having a lower surface and an upper surface;
b. a plurality of magnet receptacles formed in the lower surface of the substrate;
c. a plurality of rectangular magnets disposed within the magnet receptacles, each oriented to project a magnetic field perpendicularly from the lower surface;
d. a plurality of vertical support posts extending from the upper surface of the substrate, each support post including:
i. a central bore configured to receive a threaded fastener, such as a thread forming screw for plastic or a machine screw, depending on manufacturer specifications; and
ii. a position aligned to correspond with factory screw holes in the battery pack;
e. wherein the support posts are configured to distribute axial loads during fastening and prevent warping of the substrate during installation; and
f. wherein the magnetic base assembly is configured to magnetically adhere a cordless tool battery to a ferrous vertical surface.

2. The magnetic base assembly of claim 1, wherein the rectangular magnets are neodymium magnets of grade N42 or higher.

3. The magnetic base assembly of claim 1, wherein the magnets are arranged in a spatial configuration that offsets adjacent like poles to reduce negative polarity interference.

4. The magnetic base assembly of claim 1, wherein the magnet receptacles include dovetail or tapered walls to resist shear displacement of the magnets.

5. The magnetic base assembly of claim 1, further comprising:
a. an outer compression flange extending from the perimeter of the substrate;
b. wherein the flange provides lateral stabilization and minimizes deformation during torque application.

6. The magnetic base assembly of claim 1, wherein the support posts are integrally molded with the substrate.

7. The magnetic base assembly of claim 1, wherein the support posts are modular and removably attachable to the substrate via keyed couplings.

8. The magnetic base assembly of claim 1, further comprising alignment features selected from the group consisting of:
a. notches;
b. pins; and
c. registration ridges,
wherein the alignment features assist in positioning the magnetic base relative to the battery pack.

9. The magnetic base assembly of claim 1, further comprising a textured or knurled peripheral edge to facilitate manual handling.

10. The magnetic base assembly of claim 1, wherein the base is composed of a thermoplastic polymer selected from the group consisting of:
a. acrylonitrile butadiene styrene (ABS);
b. polycarbonate; and
c. glass-filled nylon.

11. The magnetic base assembly of claim 1, further comprising:
a. an optional modular cartridge system configured to allow field-replaceable magnetic inserts;
b. wherein the cartridges retain the magnets and are securable within corresponding cavities in the substrate.

12. A method of mounting a cordless power tool battery to a ferrous surface using the magnetic base assembly of claim 1, comprising the steps of:
a. removing factory-installed screws from the bottom of the battery pack;
b. aligning the magnetic base assembly such that each support post aligns with a corresponding screw hole;
c. inserting fasteners through the support posts into the screw holes to affix the base; and
d. magnetically coupling the modified battery pack to a vertical ferrous surface.

13. The method of claim 12, wherein the base maintains planar contact with the ferrous surface by distributing mechanical loads through the support posts.

14. The method of claim 12, wherein the magnetic base assembly permits non-destructive and reversible attachment to the battery pack.

15. A universal magnetic base system comprising:
a. a base assembly in accordance with claim 1; and
b. an adapter interface plate configured to couple with a plurality of cordless tool battery formats via adjustable retention mechanisms.
